(19) United States
(12) Patent Application Publication
(10) Pub. No.: US 2013/0080622 A1
(43) Pub. Date: Mar. 28, 2013

(54) NETWORK STATUS INDICATION SYSTEM AND MOUSE WITH NETWORK STATUS INDICATION FUNCTION

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/284,972

(22) Filed: Oct. 30, 2011

(30) Foreign Application Priority Data
Sep. 28, 2011 (CN) 201110298618.7

(51) Int. Cl. G06F 15/173

(52) U.S. Cl. 709/224

(57) ABSTRACT

A network status indication system includes a network controller, a first personal system (PS)/2 interface, and a mouse. The first PS/2 interface includes first and second idle pins. The mouse includes a second PS/2 interface, and first and second indicators. When the network controller determines that the first PS/2 interface is connected to the network, the network controller controls the first indicator to emit light. When the network controller determines that the first PS/2 interface is transmitting or receiving data with the network, the network controller controls the second indicator to flicker.

### 1. TECHNICAL FIELD

The present disclosure relates to a network status indication system and a mouse with network status indication function.

### 2. DESCRIPTION OF RELATED ART

Many computer network cards have two indicators. One of the indicators is a signal indicator to indicate network connection status. The signal indicator lights when the computer is correctly connected to network. The other indicator indicates the transmission and the reception of data packets, by flickering. Consequently, the network status of the computer can be observed through the indicators. However, the indicators of many computer network cards are disposed in the rear of the computer, and cannot conveniently be seen.

### BRIEF DESCRIPTION OF THE DRAWINGS

Many aspects of the present embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an exemplary embodiment of a network status indication system, wherein the network status indication system includes a mouse.

FIG. 2 is a schematic view of the mouse of FIG. 1.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

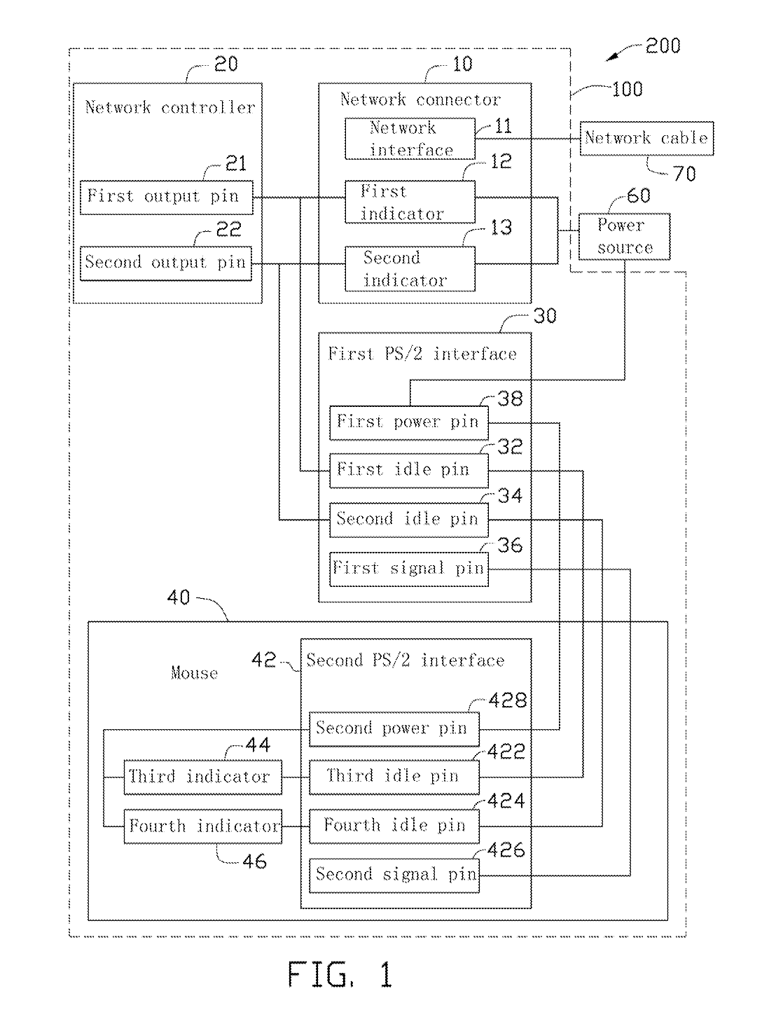

Referring to FIG. 1, an embodiment of a network status indication system 100 is applied in a computer 200, to indicate the network connection status and data transmission status of the computer 200. The network status indication system 100 includes a network connector 10, a network controller 20, a first personal system (PS)/2 interface 30, and a mouse 40. The network connector 10 and the first PS/2 interface 30 are mounted on a back panel of the enclosure of the computer 200. The network controller 20 is mounted in the enclosure of the computer 200. The mouse 40 may be a trackball or similar device performing the functions of a mouse.

The network connector 10 includes a network interface 11, and first and second indicators 12 and 13 located at one side of the network interface 11. The network interface 11 is connected to a network cable 70 to allow the computer 200 to communicate with a network. The first indicator 12 is used to indicate whether the network connection status of the computer 200 is normal. If the indicator 12 emits light, it denotes that the network connection status of the computer 200 is normal. If the indicator 12 fails to emit light, it denotes that the network connection status of the computer 200 is abnormal. The second indicator 13 is used to indicate whether the computer 200 is transmitting or receiving data. If the indicator 13 is flickering, it denotes that the computer 200 is transmitting or receiving the data. If the indicator 13 is not flickering, it denotes that the computer 200 is not transmitting or receiving the data.

The first PS/2 interface 30 includes a first idle pin 32, a second idle pin 34, a first signal pin 36, and a first power pin 38. The first power pin 38 is connected to a power source 60.

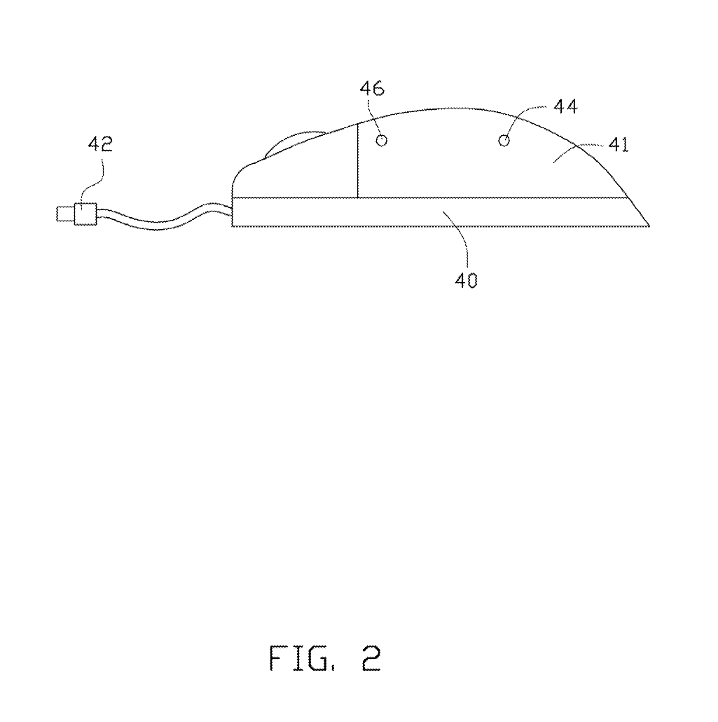

Referring to FIG. 2, the mouse 40 includes an enclosure 41, a second PS/2 interface 42, and third and fourth indicators 44 and 46 mounted on the enclosure 41. The third and fourth indicators 44 and 46 each have two terminals. The second PS/2 interface 42 is connected to the first PS/2 interface 30. The second PS/2 interface 42 includes a third idle pin 422, a fourth idle pin 424, a second signal pin 426, and a second power pin 428. First terminals of the third and fourth indicators 44 and 46 are connected to the second power pin 428. A second terminal of the third indicator 44 is connected to the third idle pin 422. A second terminal of the fourth indicator 46 is connected to the fourth idle pin 424. The third indicator 44 is used to indicate whether the network connection status of the computer 200 is normal. If the indicator 44 emits light, it denotes that the network connection status of the computer 200 is normal. If the indicator 44 fails to emit light, it denotes that the network connection status of the computer 200 is abnormal. The fourth indicator 46 is used to indicate whether the computer 200 is transmitting or receiving the data. If the fourth indicator 46 is flickering, it denotes that the computer 200 is transmitting or receiving the data. If the fourth indicator 46 is not flickering, it denotes that the computer 200 is not transmitting or receiving the data.

When the second PS/2 interface 42 is connected to the first PS/2 interface 30, the third idle pin 422 is connected to the first idle pin 32. The fourth idle pin 424 is connected to the second idle pin 34. The second signal pin 426 is connected to the first signal pin 36. The second power pin 428 is connected to the first power pin 38.

The network controller 20 includes a first output pin 21 and a second output pin 22. The first output pin 21 is connected to a first terminal of the first indicator 12, and is also connected to the first idle pin 32 of the first PS/2 interface 30. The second output pin 22 is connected to a first terminal of the second indicator 13, and is also connected to the second idle pin 34 of the first PS/2 interface 30. Second terminals of the indicators 12 and 13 are connected to the power source 60.

When the network controller 20 determines that the network interface 11 is connected to the network cable 70, the first output pin 21 outputs a low level signal, such as logical 0, to the first terminal of indicator 12, and outputs the low level signal to the second terminal of the indicator 44 through the first idle pin 32 of the first PS/2 interface 30 and the third idle pin 422 of the second PS/2 interface 42. At that time, the first and third indicators 12 and 44 both emit light, which denotes that the network connection status of the computer 200 is normal.

When the network controller 20 determines that the computer 200 is receiving or transmitting or receiving data, the second output pin 22 outputs a pulse signal to the first terminal of the second indicator 13, and outputs the pulse signal to the second terminal of the fourth indicator 46 through the second idle pin 34 of the first PS/2 interface 30 and the fourth idle pin 424 of the second PS/2 interface 42. When the second and fourth indicators 13 and 46 receive a low level signal from the pulse signal, the second and fourth indicators 13 and 46 emit light. When the second and fourth indicators 13 and 46 receive a high level signal from the pulse signal, the second and fourth indicators 13 and 46 do not emit light. Therefore, when the second and fourth indicators 13 and 46 receive the pulse signal, the second and fourth indicators 13 and 46 flicker. It denotes that the computer 200 is transmitting or receiving the data.

Although numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A network status indication system applied to a computer to indicate network connection status and data transmission status of the computer, the network status indication system comprising:
a network interface to connect to a network cable;
a first personal system (PS)/2 interface comprising a first idle pin and a second idle pin;
a network controller connected to the network interface to determine whether the network interface is connected to the network cable, and determine whether the computer is transmitting or receiving data, the network controller connected to the first and second idle pins; and
a mouse comprising:
an enclosure;
a second PS/2 interface detachably engaged with the first PS/2 interface, and comprising a third idle pin and a fourth idle pin;
a first indicator mounted on the enclosure and connected to the third idle pin, to indicate whether the network connection status of the computer is normal; and
a second indicator mounted on the enclosure and connected to the fourth idle pin, to indicate whether the computer is transmitting or receiving the data;
wherein when the first PS/2 interface is inserted into the second PS/2 interface, the first idle pin is connected to the third idle pin, the second idle pin is connected to the fourth idle pin, when the network controller determines that the computer is connected to the network cable, the network controller controls the first indicator to emit light through the first and third idle pins, when the network controller determines that the computer is transmitting or receiving the data, the network controller controls the second indicator to flicker through the second and fourth idle pins.

2. The network status indication system of claim 1, further comprising a third indicator and a fourth indicator, wherein the third and fourth indicators are mounted at one side of the network interface, and connected to the network controller, when the network controller determines that the computer is connected to the network cable, the network controller controls the third indicator to emit light, when the network controller determines that the computer is transmitting or receiving the data, the network controller controls the fourth indicator to flicker.

3. The network status indication system of claim 1, wherein the first PS/2 interface further comprises a first power pin, the second PS/2 interface further comprises a second power pin, the first power pin is connected to a power source, first terminals of the third and fourth indicators are connected to the second power pin, a second terminal of the third indicator is connected to the third idle pin, a second terminal of the fourth indicator is connected to the fourth idle pin.

4. A mouse to be inserted into a first PS/2 interface of a computer to indicate network connection status and data transmission status of the computer, the mouse comprising:
an enclosure;
a first indicator mounted on the enclosure to indicate whether the network connection status of the computer is normal; and
a second indicator mounted on the enclosure to indicate whether the computer is transmitting or receiving the data;
wherein the second PS/2 interface is operable to be inserted into the first PS/2 interface of the computer, when a network controller of the computer determines that the computer is connected to the network, the network controller controls the first indicator to emit light through the first idle pin connected to a third idle pin of the first PS/2 interface, when he network controller determines that the computer is transmitting or receiving data, the network controller controls the second indicator to flicker through the second idle pin connected to a fourth idle pin of the first PS/2 interface.

5. The mouse of claim 4, wherein the second PS/2 interface further comprises a first power pin connected to a second power pin of the first PS/2 interface in response to the second PS/2 interface being inserted into the first PS/2 interface, first terminals of the first and second indicators are connected to the first power pin, a second terminal of the third indicator is connected to the third idle pin, a second terminal of the fourth indicator is connected to the fourth idle pin.
